(19) United States
(12) Patent Application Publication
(10) Pub. No.: US 2026/0319903 A1
(43) Pub. Date: Oct. 15, 2026

(54) TEST ERROR PRESENTATION

(71) Applicant: TOYOTA JIDOSHA KABUSHIKI KAISHA, Toyota-shi (JP)

(72) Inventor: Linyu SUN, Miyoshi-shi (JP)

(73) Assignee: TOYOTA JIDOSHA KABUSHIKI KAISHA, Toyota-shi (JP)

(21) Appl. No.: 19/177,958

(22) Filed: Apr. 14, 2025

(51) Int. Cl. G06F 11/32; G06F 3/0484; G06F 11/34

(52) U.S. Cl. CPC G06F 11/321; G06F 3/0484; G06F 11/3476

(57) ABSTRACT

Example embodiments of the present disclosure relate to test error presentation. According to example embodiments, a method for presenting a test error of a performed test to a user may include: receiving, by a device, a log file associated with the performed test and outputting, by the device and to a user device associated with the user, a graphical user interface (GUI) that presents information of the log file. The GUI may comprise a playbar that includes: a playback timeline visually representing a duration of the performed test, a first interactive element visually representing an error zone corresponding to a portion of the log file associated with the test error and configured to enable the user to interact with the test error, and a second interactive element configured to enable the user to control the playback of the information of the log file along the playback timeline.

### TECHNICAL FIELD

The present disclosure relates to test error presentation, and more particularly, relates to presenting to a user a test error in a log file of a performed test.

### BACKGROUND

The information disclosed in this background section is only for the enhancement of understanding of the general background of the disclosure and should not be taken as an acknowledgement or any form of suggestion that this information forms the prior art already known to a person skilled in the art.

A testing is an essential and crucial stage in developing a system, in order to ensure the reliability, performance, and safety of the system. During the testing stage, various testing may be performed on the software, hardware, or the combination thereof, of the system. A test error may be identified when a test object experiences an unexpected behavior during the testing. The test error may be recorded in a log file, along with contextual details such as the timestamps, testing parameters, and the like.

### SUMMARY

Example embodiments of the present disclosure provide devices, systems, methods, and the like, that effectively and efficiently present a test error of a performed test to a user.

According to example embodiments, a method for presenting a test error of a performed test to a user may include: receiving, by a device, a log file associated with the performed test and outputting, by the device and to a user device associated with the user, a graphical user interface (GUI) that presents information of the log file. The GUI may comprise a playbar that includes: a playback timeline visually representing a duration of the performed test, a first interactive element visually representing an error zone corresponding to a portion of the log file associated with the test error and configured to enable the user to interact with the test error, and a second interactive element configured to enable the user to control the playback of the information of the log file along the playback timeline.

According to example embodiments, a device for presenting a test error of a performed test to a user may include a memory storage storing computer-executable instructions and a processor communicatively coupled to the memory storage. The processor may be configured to execute the instructions to: receive a log file associated with the performed test and output, to a user device associated with the user, a GUI that presents information of the log file. The GUI may comprise a playbar that includes: a playback timeline visually representing a duration of the performed test, a first interactive element visually representing an error zone corresponding to a portion of the log file associated with the test error and configured to enable the user to interact with the test error, and a second interactive element configured to enable the user to control the playback of the information of the log file along the playback timeline.

According to example embodiments, a non-transitory computer-readable recording medium having recorded thereon instructions executable by a device to cause the device to perform a method for presenting a test error of a performed test to a user. The method may include: receiving, by a device, a log file associated with the performed test and outputting, by the device and to a user device associated with the user, a GUI that presents information of the log file. The GUI may comprise a playbar that includes: a playback timeline visually representing a duration of the performed test, a first interactive element visually representing an error zone corresponding to a portion of the log file associated with the test error and configured to enable the user to interact with the test error, and a second interactive element configured to enable the user to control the playback of the information of the log file along the playback timeline.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIGS. 1A and 1B each illustrates a diagram of an example system architecture, according to one or more example embodiments;

FIG. 2A illustrates a diagram of an example method for presenting a test error of a performed test to a user, according to one or more example embodiments;

FIG. 2B illustrates an example playbar, according to one or more example embodiments;

FIG. 3A illustrates a diagram of an example method for presenting information associated with an error zone, according to one or more example embodiments;

FIG. 3B illustrates a diagram an example use case for presenting information associated with the error zone, according to one or more example embodiments;

FIGS. 4A and 4B each illustrates a diagram of an example use case in which a first interactive element of the playbar includes a plurality of interactive portions, according to one or more example embodiments;

FIG. 4C illustrates a graph of an example use case where a test error occurs, according to one or more example embodiments;

FIG. 5 illustrates a diagram of an example method for outputting information of a condition associated with an interactive portion, according to one or more example embodiments;

FIG. 6 illustrates a diagram of an example method for presenting information of the log file, according to one or more example embodiments;

FIG. 7 illustrates a diagram of an example method for outputting a graph that represents the information of the log file, according to one or more example embodiments;

FIGS. 8A to 8H illustrate an example use case associated with the outputting of the graph and dynamically updating the graph, according to one or more example embodiments; and

FIG. 9 illustrates a diagram of example components of a device, according to one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc. In addition, expressions such as “a processor may be configured to perform an operation,” are to be understood as the processor may be configured to execute computer-executable instructions or programming codes to thereby perform an operation. Namely, the instructions or programming codes may be configured to cause the processor to perform an operation.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, testing of a system is an important aspect in the development and management of a system and the associated components, such as the software components, hardware components, or combination thereof. In this regard, analyzing test errors in a test log file is crucial for diagnosing system failures and enhancing the system. Nevertheless, as described below, the approaches in presenting test errors of log files in the related art are suboptimal and contain several shortcomings, leading to inefficiency and ineffective in enabling the user to identify and analyze the test errors.

Specifically, in the related art, when a test error occurs during a performed test, users are required to manually check and sift through the associated log file(s) to identify the test error occurs (e.g., determine the exact moment the test error occurs, etc.). This process is time-consuming and error-prone, given that the log file(s) can be large and highly complex, often containing a large amount of data that obscure the information associated with the test error.

Further, in the related art, determining and identifying specific conditions and reasons of a test error may be challenging, particularly for less-experienced users. Specifically, when a test error occurs, the users are often required to manually cross-reference multiple log entries and review historical test data to identify the occurrence of a similar test error. This process involves analyzing complex data relationships that are not readily presented in the log file(s), making it difficult to distinguish which condition(s) directly causes the test error, which condition(s) is associated with (but is not causing or not directly causing) the test error, and which condition(s) is not related to the test error. Accordingly, the approach in the related art can be tedious, inefficient, and time-consuming.

Furthermore, in the related art, the log files typically contain only the information associated with the test execution process and the result(s) of the process. However, this information is often presented in a raw, non-integrated format, and the key information associated with the test error (e.g., error descriptions, reasons/causes, resolution, etc.) is often scattered across the log files (or external documentation), making it difficult for users to effectively and efficiently extract meaningful insights without detailed analysis and manual aggregation/consolidation of data.

In addition, in the related art, log files are typically static and presented in raw, unstructured formats without dynamic, interactive, or visualization features. This static nature makes it challenging for users (particularly users with less experience) to review and extract meaningful insights from the log files.

Example embodiments of the present disclosure, as described in the following, provide devices, systems, methods, and the like, that effectively and efficiently present, to a user, information of a test error in a log file, and ultimately address the shortcomings of the related art systems and methods.

Specifically, example embodiments of the present disclosure provide systems, devices, methods, operations, and the like, that output a graphical user interface (GUI) that includes a playbar. The playbar may include interactive elements that, when being interacted by the user, enable the user to manage the playback (e.g., initiate, pause, stop, etc.) of a test log file. The playbar also includes an interactive element that visually represents an error zone corresponding to a portion of the log file associated with the test error. The error zone may be visually distinguished from other portions of the playbar, thereby intuitively notifying the user about the portion of the log file that contains the test error. Further, the error zone, when being interacted by the user, may present information of the test error to the user. In addition, during the playback of the log file, a graph may also be presented to the user. The graph is continuously (or periodically) updated on the fly along with the playback of the log file, while the error zone is visually emphasized in the graph.

Accordingly, example embodiments may automate the presentation of a test error and eliminate the need for manual log file analysis, thereby reducing the analysis time, increasing the review efficiency, and reducing human errors. Further, example embodiments may also provide an intuitive and interactive interface that includes comprehensive information about the test error, thereby enabling the users (particularly the less-experienced users) to effectively and efficiently understand the error context, the associated key information (including information of conditions that are associated with, but not causing or not directly causing the test errors ), and the relationship thereof. Furthermore, example embodiments may provide dynamic feedback by visually updating the graph (that presents the information of the log file and test error) and visual elements in real-time, thereby enhancing user experiences and simplifying the presentation of the information (particularly the key information and useful insights).

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

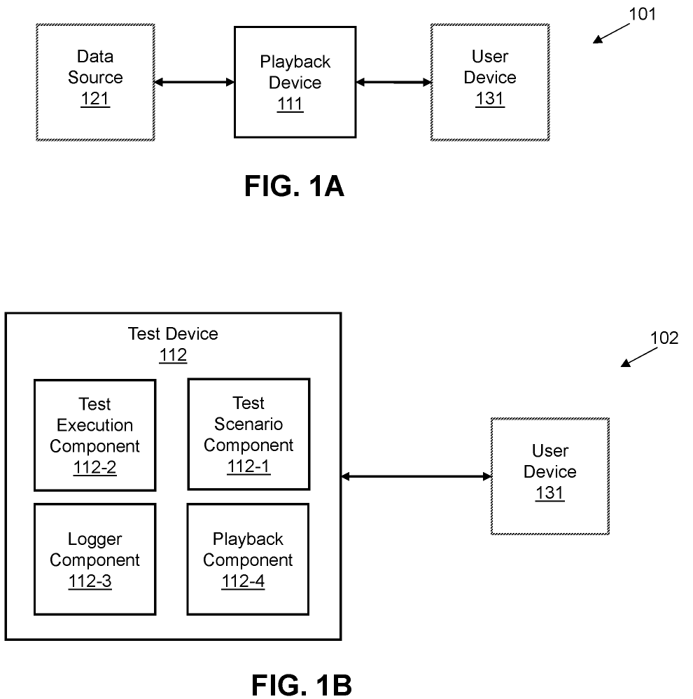

FIGS. 1A and 1B each illustrates a diagram of an example system architecture, according to one or more example embodiments. Specifically, FIG. 1A illustrates a diagram of an example system 101 in which the main operations of example embodiments (e.g., outputting a GUI that includes a playbar that playback information of a log file, outputting a graph along with the playback of the log file, etc.) are implemented by a playback device, while FIG. 1B illustrates a diagram of an example system 102 in which the main operations of example embodiments are implemented in a playback component of a test device.

Referring first to FIG. 1A, the system 101 may include a playback device 111, a data source 121, and a user device 131. Generally, the playback device 111 may obtain a log file from the data source 121 and output a GUI to the user device 131 to playback the information of the log file and present information of a test error (if any) thereon.

The playback device 111 may operate as a dedicated device that implements one or more components for log file analysis and test error presentation. In some example implementations, the “playback device” may also be referred to as an “analyzer device” and may be implemented as a component in a log file analyzing system. It is contemplated that the “playback device” may also be referred to as a “playback component,” an “analyzer component,” and any other suitable terminologies, without departing from the scope of the present disclosure.

The data source 121 may include a device, system, component, and the like, that performs/executes a test and creates the log file associated therewith. Additionally or alternatively, the data source 121 may also include a device, system, component, and the like, that stores and manages the log file, such as a storage medium external to the playback device 111 (e.g., a network storage device, a physical storage device, etc.), a storage medium internal to the playback device 111 (e.g., internal storage medium of the playback device 111, etc.), or a combination thereof.

The user device 131 may include a device, component, equipment, and the like, that may be utilized by a user to communicate with the playback device 111 and display thereon a GUI provided by the playback device 111. The “user” described herein may include a test engineer, a system (e.g., software and/or hardware) developer, and any other suitable personnel that is authorized to access the system 101. In this regard, the user device 131 may include one or more hardware devices, such as a workstation, a personal computer (PC), a tablet, a smartphone, a service, a dedicated terminal, and the like. Additionally or alternatively, the user device 131 may include one or more software tools, such as a web application, a mobile application, an integrated client software, and the like, that is hosted or implemented in a hardware device and configured to display the GUI provided by the playback device 111.

According to example embodiments, the playback device 111 may analyze the log file received or obtained from the data source 121, and then output or provide a GUI that represents information of the log file to the user device 131. In some example implementations, the user device 131 may include a display component that may be configured to display the GUI provided by the playback device 111. In this regard, the playback device 111 may generate instructions associated with the GUI (e.g., Hypertext Markup Language (HTML), JavaScript (JS), JavaScript Object Notation (JSON), Cascading Style Sheets (CSS), or any other structured data or programming languages that describe the layout and content of the GUI) and send the instructions to the user device 131 (via a wired connection, wireless connection or a combination thereof). The user device 131 may then generate and display the GUI (e.g., on a display, etc.) based on the instructions provided by the playback device 111. Additionally or alternatively, the playback device 111 may include a display component that may be configured to display the GUI. In this regard, upon analyzing the log file, the playback device 111 may generate and display the GUI on the associated display component. The user device 131 may serve as a remote access interface or remote control tool that allows the associated user to interact with the playback device 111, a supplementary or secondary display that mirrors or extends the information shown on the playback device 111, and the like.

Referring next to FIG. 1B, the system 102 may include a test device 112 and a user device 131 (which may be similar to the user device 131 in system 101). The test device 112 may include a test scenario component 112-1, a test execution component 112-2, a logger component 112-3, and a playback component 112-4. Each of the components in test device 112 may be implemented or deployed in software form, hardware form, or a combination thereof. Further, said components may be implemented in the same device or different devices. In this regard, descriptions such as “playback component may perform an operation,” “playback component may be configured to perform an operation,” “a device may be configured to implement the playback component to perform an operation,” and the like, may be interpreted as “a device (or a hardware component) may execute computer-readable instructions or programming codes associated with the playback component to perform an operation associated therewith”.

Generally, a user may access the test device 112 (via the user device 131, etc.) to specify a test scenario and a logger setting. Accordingly, the test device 112 may execute the test according to the test scenario and log data of the test according to the logger setting to thereby produce a log file. Subsequently, the test device 112 may output a GUI to the user device 131 to present and playback the information of the log file.

In this example system, the operations and features associated with the specification of the test scenario (e.g., defining test conditions, specifying expected test outputs, selecting parameters that define a test error, etc.) are implemented by the test scenario component 112-1. Further, the operations and features associated with the execution of the test (e.g., run the test according to the test scenario) are implemented by the test execution component 112-2, and the operations and features associated with the logging of test data (e.g., record test parameters and results according to the user-configured logger settings, generate and store a log file, etc.) are implemented by the logger component 112-3. On the other hand, the presentation and playback of the information of the log file (e.g., analyzing the log file, providing/generating the GUI to present the information of the log file, etc.) are implemented by the playback component 112-4.

In view of the above, in system 102, the operations and functions of the playback device 111 in system 101 may be implemented by or integrated into the test device 112, which enables the test device 112 to act as a comprehensive device that not only enables test configuration, execution, and logging, but also allow for the presentation of test information (including information of a test error, if any).

It is contemplated that the system 101 in FIG. 1A and the system 102 in FIG. 1B are merely examples and the configuration of the systems and components therein may vary according to the requirements or implementations. For instance, in some example embodiments, multiple data sources 121 and user devices 131 may be implemented in system 101, multiple components of the test device 112 may be combined and implemented as one component, and the like, without departing from the scope of the present disclosure.

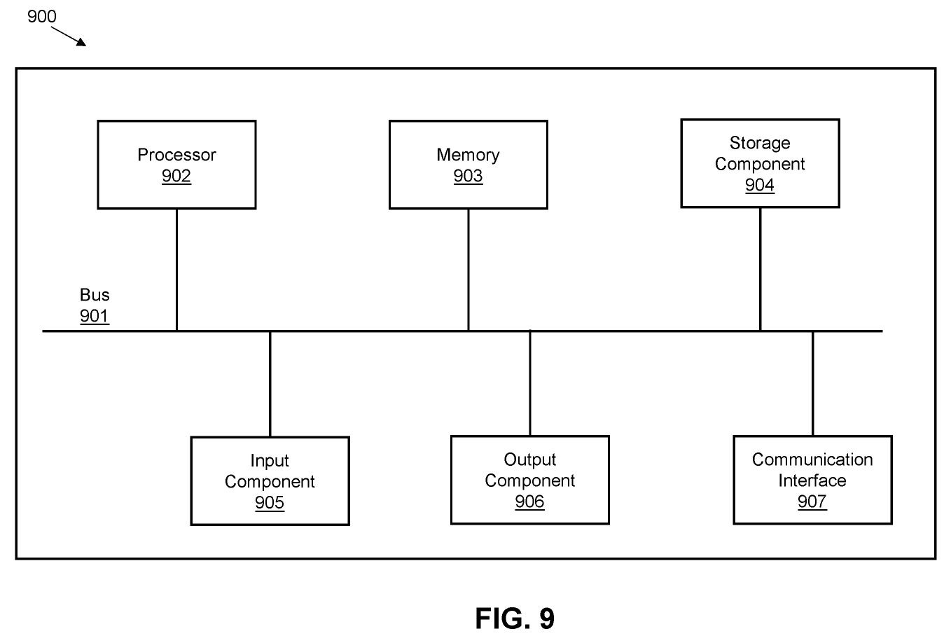

Furthermore, one or more of the components in system 101 and system 102, such as the component(s) in the playback device 111 and the component(s) in the test device 112, may be implemented in software form, hardware form, or a combination thereof. For instance, these components may be implemented as one or more virtualized/containerized functions or software applications, and may be deployed on a device or hardware component. An example device that may be configured to implement one or more components of system 101 and system 102 (e.g., the component(s) of the playback device 111, the component(s) of the test device 112, etc.) are described below with reference to FIG. 9.

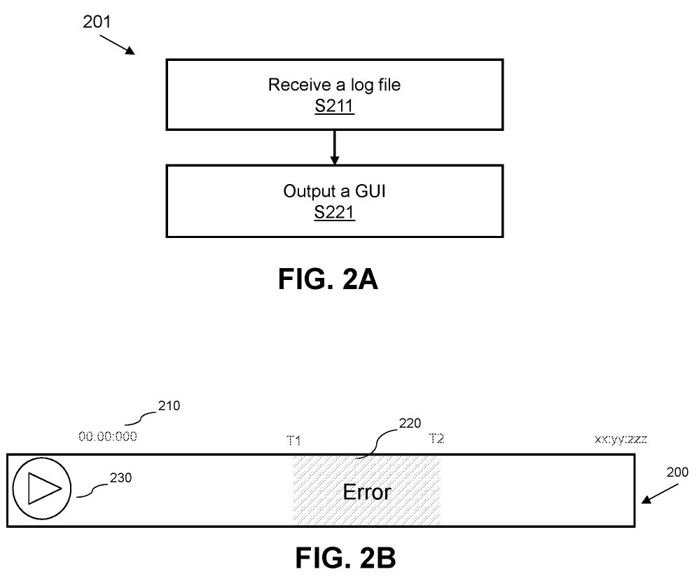

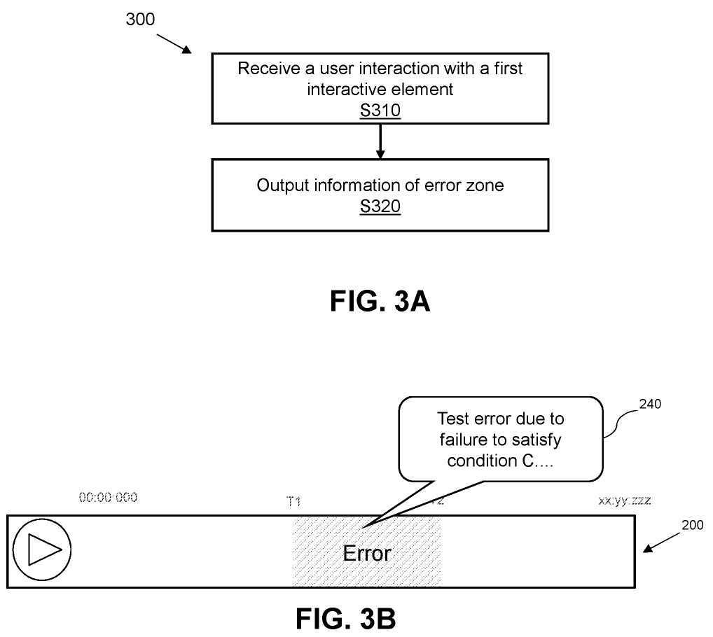

Further descriptions of example methods and operations associated with the example embodiments, as well as example use cases associated therewith, are provided below with reference to FIGS. 2A to 8H.

### Example Methods, Operations, and Use Cases

The components in FIGS. 1A and 1B may be configured to interoperate with each other and perform one or more methods and operations to efficiently and effectively present information of a log file (including a test error, if any) to a user. In the following, descriptions of several example methods and the associated operations, as well as several example use cases, are provided.

One or more components and operations (as well as the data involved therein) may be similar to those described above with reference to FIGS. 1A and 1B, thus it may be understood that the descriptions provided above with reference to FIGS. 1A and 1B may be similarly applied to the methods, operations, and use cases described hereinbelow (unless described otherwise) and redundant descriptions associated therewith may be omitted for conciseness.

For descriptive purposes, the methods, operations, and use cases may be mainly described as being performed by one or more specific components, although it can be understood that, in actual implementations, another related component(s) may perform similar/related methods, operations, and use cases, without departing from the scope of the present disclosure. For instance, an operation of the playback device receiving a data from th1e data source may indicate or suggest an operation of the data source providing the data to the playback device, and the like.

As described above, according to example embodiments, one or more components in FIGS. 1A and 1B may be implemented in one or more devices or hardware components, thus one or more methods, operations, and use cases described hereinbelow may be performed by the one or more devices/hardware components. For instance, the playback component 112-4 may be implemented in one or more devices that include a processor and a memory storage (or any other suitable storage mediums), wherein the memory storage may include computer-executable instructions or programming codes which, when being executed by the processor, cause the processor to perform one or more operations associated therewith. Similarly, the playback device 111 may include a processor and a memory storage (or any other suitable storage mediums) that may be configured to interoperate in a similar manner to perform one or more operations associated therewith.

FIG. 2A illustrates a diagram of an example method 201 for presenting a test error of a performed test to a user, according to one or more example embodiments. For descriptive purposes, the operations of method 201 are described as being performed by a “device”, which may include a playback device (e.g., device 111 in FIG. 1A) or a device that implements a playback component (e.g., device 112 in FIG. 1B).

Referring to FIG. 2A, at operation S211, the device may be configured to receive a log file associated with the performed test. Specifically, the device may receive (or obtain) the log file from an external storage medium (e.g., a server, a physical storage device, etc.), an internal storage medium (e.g., a memory or a storage of the device, etc.), or a combination thereof. In some example embodiments, the device may be configured to obtain the log file from another device (e.g., a test device, a device that manages the log file, etc.).

Upon receiving the log file, at operation S221, the device may be configured to output, to a user device associated with the user, a Graphical User Interface (GUI) that presents information of the log file. In some example embodiments, the GUI may include a playbar. In this regard, a “playbar” described herein may refer to a horizontal interactive element in the GUI that enables a user to interact therewith, thereby enabling the user to control the playback of the information of the log file, such as play, pause, rewind, and the like, the information along a timeline.

FIG. 2B illustrates a playbar 200 of an example GUI, according to one or more example embodiments. In this example use case, the playbar 200 includes a playback timeline 210, a first interactive element 220, and a second interactive element 230.

The playback timeline 210 may visually represent a duration of the performed test. In the example of FIG. 2B, the playback timeline 210 includes an initial time that indicates the starting of the performed test (illustrated as “00:00:000” in FIG. 2B) and an ending time that indicates the ending of the performed test (illustrated as “xx:yy:zzz” in FIG. 2B). Further, the playback timeline 210 also includes a starting time of the first interactive element 220 (illustrated as “T1” in FIG. 2B) and an ending time of the first interactive element 220 (illustrated as “T2” in FIG. 2B).

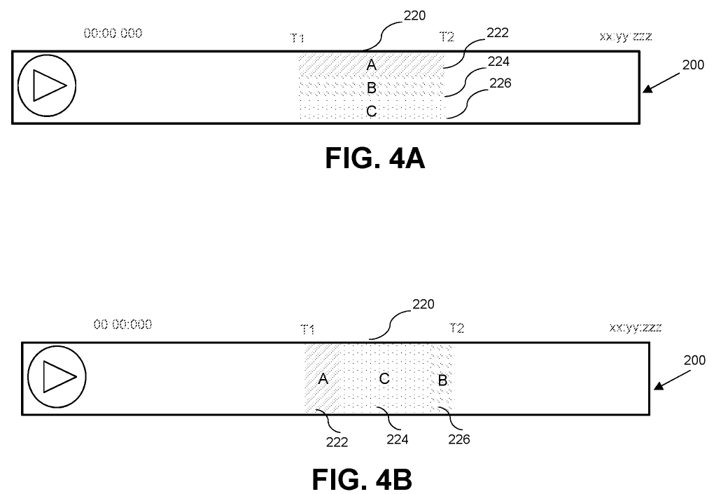

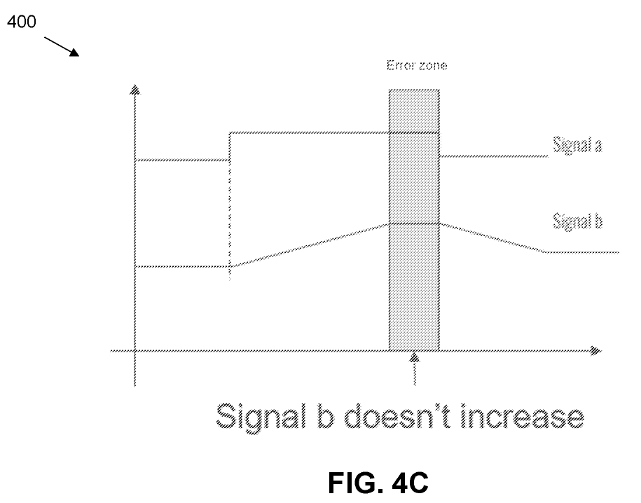

The first interactive element 220 may visually represent an error zone corresponding a portion of the log file associated with the test error. It is contemplated that the size of the illustrated first interactive element 220 is merely an example, and the size (e.g., length, etc.) of the first interactive element 220 may vary in actual implementations (e.g., shorter element 220 when the error zone is shorter, longer element 220 when the error zone is longer, etc.). According to example embodiments, the first interactive element 220 may be configured to enable the user to interact with the test error (e.g., obtaining further details about the test error, etc.). Descriptions of an associated method and example use case are described below with reference to FIGS. 3A and 3B.

The second interactive element 230 may be configured to enable the user to control the playback of the information of the log file along the playback timeline. The second interactive element 230 may include, for example, a play button that initiates the playback, a stop button that terminates the playback, a pause button that temporarily stops the playback, a record button that records the playback, and the like. According to example embodiments, the visual representation (e.g., icon, etc.,) and the function of the second interactive element 230 may transition from one to another (e.g., a play button may transition into a pause button, etc.), upon an interaction by the user.

In the following, descriptions of example methods, operations, and use cases associated with the first interactive element are provided first, followed by descriptions of example methods, operations, and use cases associated with the second interactive element.

### Example methods, operations, and uses cases of first interactive element

FIG. 3A illustrates a diagram of an example method 300 for presenting information associated with an error zone, according to one or more example embodiments. One or more operations of method 300 may be initiated in response to a user interaction with a first interactive element of a playbar presented to the user device (e.g., the first element 220 of the playbar 200 in FIG. 2B, etc.).

Referring to FIG. 3A, at operation S310, the device may be configured to receive, from the user device, a user interaction with the first interactive element (may be referred to as the “first user interaction” herein). The first user interaction may include, for example, a user clicking on the first interactive element, a user providing an input (e.g., a text input, an audio input, etc.) to instruct the device to interact or trigger the first interactive element, and the like.

At operation S320, upon receiving the first user interaction with the first interactive element 220, the device may be configured to output information associated with the error zone. According to example embodiments, the information associated with the error zone may include at least one of: an error identification (e.g., title or description of the test error, error ID number, etc.), an error context (e.g., the name of the test case where the error occurred, the test step or phase during which the test error was detected, etc.), an error reason (e.g., a user-defined condition/scenario is satisfied, a rule is violated, incompatible/dependency issues between test components, etc.), an error impact (e.g., the severity level of the test error, affected operations, potential consequences, etc.), a log file excerpt associated with the test error (e.g., log lines corresponding to the error zone, log contexts prior to, during, or after the test error, etc.), and a suggested action to address the test error (e.g., action from a predefined action list, action determined by the device by utilizing AI/ML features, links or references to relevant troubleshooting information, etc.). It is contemplated that the information associated with the error zone may further include any other suitable information, without departing from the scope of the present disclosure.

FIG. 3B illustrates a diagram of an example use case for presenting information associated with the error zone, according to one or more example embodiments. In this example use case, it is assumed that the device has received a user interaction with the first interactive element 220 of the playbar 200 in FIG. 2B, and the device is configured to generate and output a text box 240 that includes the information associated with the error zone.

As illustrated in FIG. 3B, the text box 240 may be presented on top of (e.g., overlaying) the playbar 200. It is contemplated that the text box 240 is merely an example implementation to present the information associated with the error zone, and the scope of the present disclosure should not be limited thereto. Specifically, the information associated with the error zone may be presented in any suitable manner, such as in a new GUI, a pop-out window, and the like, without departing from the scope of the present disclosure.

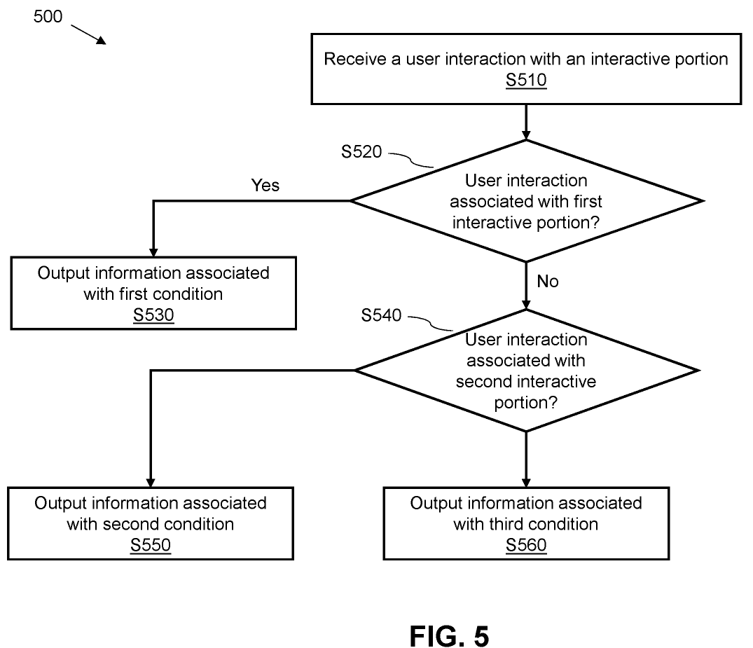

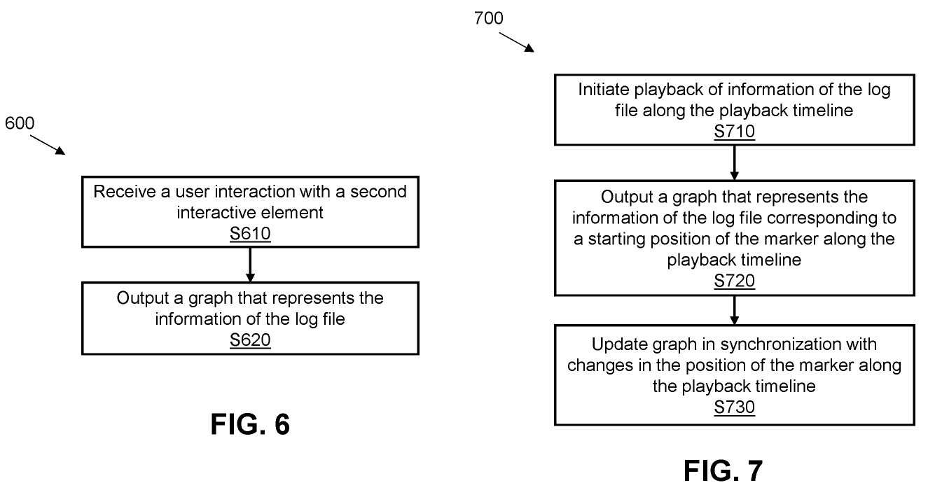

According to example embodiments, the first interactive element (e.g., element 220 in FIG. 2B) may include a plurality of interactive portions, each of which may be associated with a portion of the log file. For instance, the portion of the log file associated with the test error may include a first portion associated with a first condition that serves as a reference in determining the test error, a second portion associated with a second condition that caused the test error when compared to the first condition, and a third portion associated with a third condition that is associated with both the first condition and the second condition. In this regard, the first interactive element may include a first interactive portion associated with the first portion of the log file, a second interactive portion associated with the second portion of the log file, and a third interactive portion associated with the third portion of the log file. Several example use cases are described below with reference to FIGS. 4A and 4B.

FIG. 4A illustrates a diagram of a first example use case in which the first interactive element of the playbar 200 includes a plurality of interactive portions, according to one or more example embodiments. As illustrated in FIG. 4A, the first interactive element 220 of the playbar 200 may include a first interactive portion 222, a second interactive portion 224, and a third interactive portion 226, each of which may be associated with a corresponding portion of the log file.

FIG. 4B illustrates a diagram of a second example use case in which the first interactive element of the playbar 200 includes a plurality of interactive portions, according to one or more example embodiments. Similar to the first example use case in FIG. 4A, the playbar 200 may include a first interactive portion 222, a second interactive portion 224, and a third interactive portion 226, each of which may be associated with a corresponding portion of the log file. The difference between the example use cases in FIGS. 4A and 4B is that the interactive portions 222 to 226 of each example use case are organized or arranged differently. It is contemplated that the interactive portions 222 to 226 may also be organized or arranged in any other suitable manner, without departing from the scope of the present disclosure.

As illustrated in FIGS. 4A and 4B, according to example embodiments, the interactive portions 222 to 226 may be visually distinguished from each other. For instance, the first interactive portion 222 may be filled with a first pattern, the second interactive portion 224 may be filled with a second pattern, and the third interactive portion 226 may be filled with a third pattern. It is contemplated that the interactive portions may be visually distinguished from each other in any other suitable manner, without departing from the scope of the present disclosure. Specifically, instead of or in addition to distinguishing the interactive portions by filling each interactive portion with a specific pattern, each interactive portion may also be filled with different colors, and the like. For instance, the first interactive portion 222 may be highlighted in green (which indicates that the associated first condition is satisfied), the second interactive portion 224 may be highlighted in red (which indicates that the associated second condition is not satisfied due to a test error), and the third interactive portion 226 may be highlighted in orange (which indicates that the associated third condition is not satisfied due to an impact of other condition).

In the example use cases of FIGS. 4A and 4B, the first interactive portion 222 may be associated with a first portion of the log file, the second interactive portion 224 may be associated with a second portion of the log file, and the third interactive portion 226 may be associated with a third portion of the log file. As described above, according to example embodiments, the first portion of the log file may be associated with a first condition that may serve as a reference in determining the test error, the second portion of the log file may be associated with a second condition that caused the test error when compared to the first condition, and the third portion of the log file may be associated with a third condition that is associated with both the first condition and the second condition.

FIG. 4C illustrates a graph 400 of an example use case where a test error occurs, according to one or more example embodiments. In this example use case, a performed test may involve two signals, i.e., a first signal A and a second signal B, and the test may be considered as successful if three conditions (i.e., a first condition A, a second condition B, and a third condition C) are satisfied. For instance, the first condition A may include a predefined pattern or behavior of the first signal A, the second condition B may include a predefined pattern or behavior of the second signal B that is evaluated with reference to the first signal A, and the third condition C may refer to a condition that is satisfied when “both condition A and condition B are satisfied”.

As illustrated in FIG. 4C, the pattern/behavior of the first signal A satisfies the predefined pattern/behavior (e.g., increases from a first value to a second value at a specific time point, maintains the second value for a specific duration, reduces from the second value to the first value at a specific time point, etc.), thus the first condition A is satisfied. On the other hand, the pattern/behavior of the second signal B does not satisfy the predefined pattern/behavior (e.g., continue increasing an associated value when the signal A has the second value), since signal B stops increasing the associated value while the signal A still having the second value. Accordingly, the second condition B is not satisfied, and a test error occurs. The test duration/portion of the log file, where the test error occurs, defines the error zone. In this example, since the second condition B is not satisfied, the third condition C (which requires both the first condition A and the second condition B to be satisfied) is also not satisfied.

According to example embodiments, each of the interactive portions of the first interactive element (e.g., interactive portions 222 to 226 in FIGS. 4A and 4B), upon being interacted by the user, may trigger the device to output information associated with the respective condition.

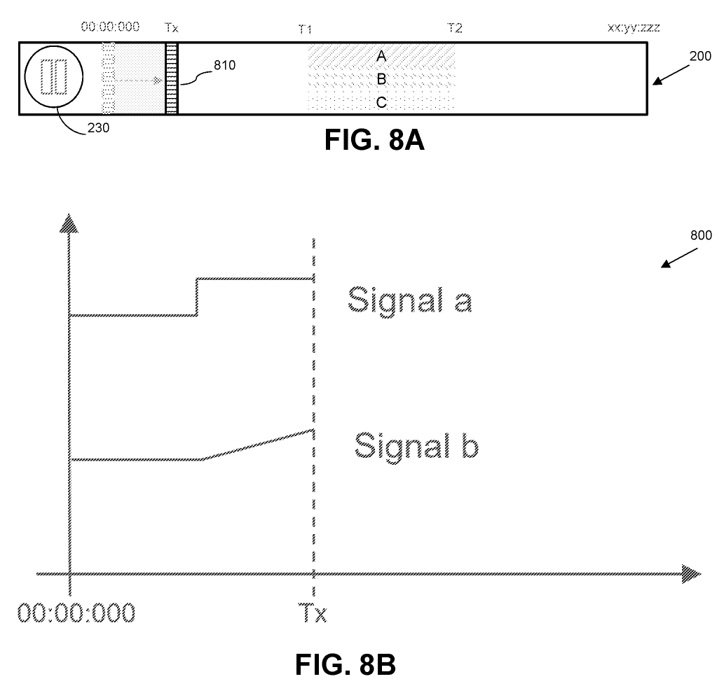

FIG. 5 illustrates a diagram of an example method 500 for outputting information of a condition associated with an interactive portion, according to one or more example embodiments. One or more operations of method 500 may be initiated in response to a user interaction with an interactive portion (e.g., interactive portions 222 to 226 in FIGS. 4A and 4B) of a first interactive element in a playbar presented to the user device (e.g., the first element 220 of the playbar, etc.).

Referring to FIG. 5, at operation S510, the device may be configured to receive a user interaction associated with an interactive portion. For instance, the device may receive, from the user device, a user interaction with at least one of: the first interactive portion 222, the second interactive portion 224, and the third interactive portion 226. The user interaction may include, for example, a user clicking on the interactive portion, a user providing input (e.g., text input, audio input, etc.) to instruct the device to interact or trigger the interactive portion, and the like.

At operation S520, the device may be configured to determine whether the user interaction is associated with the first interactive portion 222. Based on determining that the user interaction is associated with the first interactive portion 222, method 500 may proceed to operation S530, at which the device may be configured to output, to the user device, information associated with the first condition. Otherwise, method 500 may proceed to operation S540, at which the device may be configured to determine whether the user interaction is associated with the second interactive portion 224. Based on determining that the user interaction is associated with the second interactive portion 224, method 500 may proceed to operation S550, at which the device may be configured to output, to the user device, information associated with the second condition. Otherwise, the device may determine that the user interaction is associated with the third interactive portion 226, and thus method 500 may proceed to operation S560, at which the device may be configured to output, to the user device, information associated with the third condition.

According to example embodiments, the information associated with a condition (e.g., the first condition, second condition, third condition, etc.) may include: identification of the condition (e.g., title or description of the condition, an ID number of the condition, etc.), the context of the condition (e.g., the definition or parameters of the condition), a reason why the condition is not satisfied (e.g., information of the associated condition(s) that causes the test error, etc.) if applicable, and the like.

According to example embodiments, the device may be configured to output the information associated with a condition by outputting a text box overlaying the playbar, a pop-out window, a new GUI, and the like. Alternatively or additionally, the device may provide said information to the user device and notify the user device to present the information to the user.

As a non-limiting example, assuming that in the example use cases of FIGS. 4A to 4C, the device receives a user interaction on the third interactive portion 226. In this regard, since the third interactive portion 226 is associated with the third condition C, and the third condition C is associated with the first condition A and second condition B (e.g., condition C is satisfied when both of the first condition A and the second condition B are satisfied, etc.), upon receiving the user interaction on the third interactive portion 226, the device may output the information of the third condition C, as well as the information of the first condition A and the second condition B. For instance, the device may output a notification stating that a test error has occurred since the third condition C is not satisfied, and more specifically, the failure in satisfying the third condition C is due to the failure in satisfying the second condition B, and the like.

### Example methods, operations, and uses cases of second interactive element

One or more methods, operations, and uses cases described hereinbelow may be performed by a device (e.g., playback device 111 in FIG. 1A, test device 112 that implements the playback component 112-4 in FIG. 1B, etc. ), when the device receives, from a user device (e.g., user device 131 in FIGS. 1A and 1B), a user interaction on the second interactive element (e.g., element 230, such as the play button, in the playbar 200).

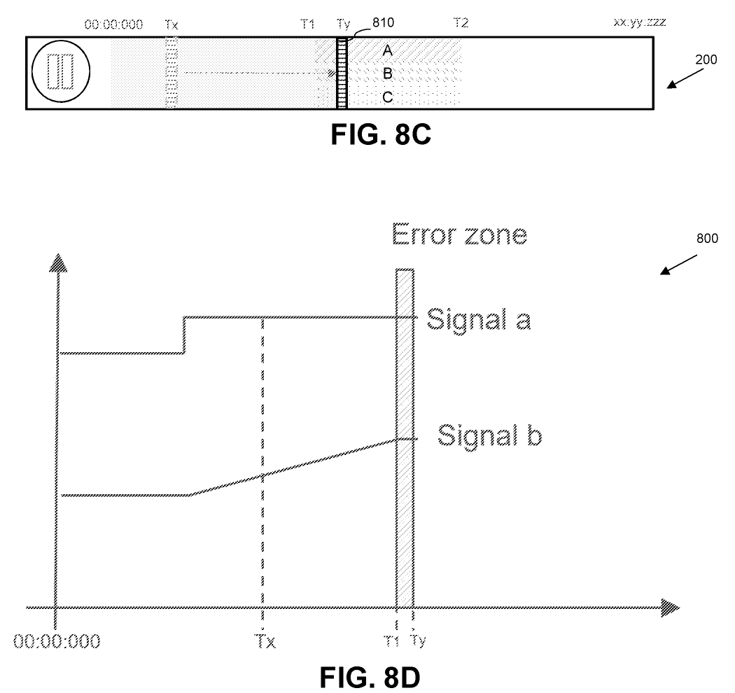

FIG. 6 illustrates a diagram of an example method 600 for outputting a graph that represents the information of the log file, according to one or more example embodiments. At operation S610, the device may be configured to receive, from the user device, a user interaction with the second interactive element (may be referred to as the “second user interaction” herein). The second user interaction may include, for example, a user clicking on the second interactive element, a user providing an input (e.g., a text input, an audio input, etc.) to instruct the device to interact or trigger the second interactive element, and the like.

According to example embodiments, the second interactive element may be configured to, upon being interacted by the user, initiate, pause, or stop the playback of the information of the log file along the playback timeline (e.g., timeline 210 in the playbar 200). Merely for descriptive purposes, it is assumed herein that the second interactive element is a play button that may be configured to initiate the playback of the information of the log file, upon receiving the second user interaction. In some other example implementations, the second interactive element may be a pause button that may be configured to pause the playback of the information of the log file, upon receiving the second user interaction. Alternatively, the second interactive element may be a stop button that may be configured to stop the playback of the information of the log file, upon receiving the second user interaction.

Accordingly, at operation S620, the device may be configured to output, to the user device, a graph that represents the information of the log file. In this regard, the error zone may be visually emphasized in the graph. For example, the error zone may be highlighted in any suitable color in the graph, may be filled with a specific pattern, and the like.

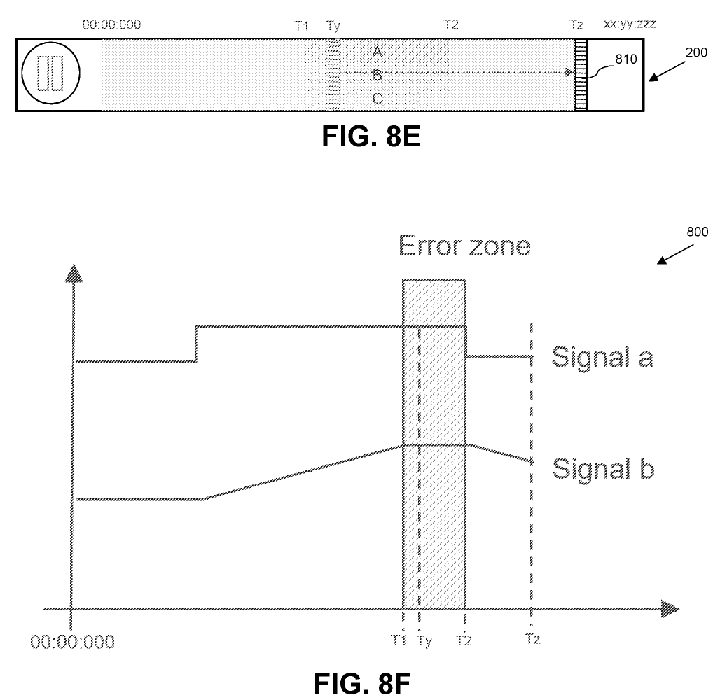

FIG. 7 illustrates a diagram of an example method 700 for outputting and updating the graph that represents the information of the log file, according to one or more example embodiments. One or more operations in method 700 may be part of operation S620 in method 600.

Referring to FIG. 7, at operation S710, the device may be configured to initiate the playback of the information of the log file along the playback timeline (e.g., timeline 210 in the playbar 200). This operation may be initiated or triggered, after the device receives the second user interaction from the user device (at operation S610 in method 600).

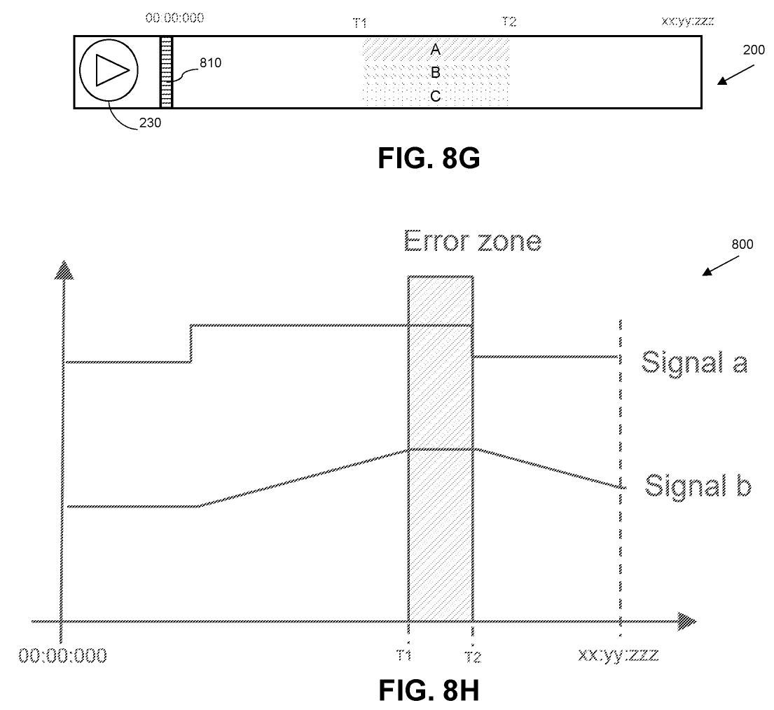

At operation S720, the device may be configured to output the graph that presents information of the log file corresponding to a starting position of a marker along the playback timeline. In this regard, the marker may refer to an interactive element in the playbar that indicates a current playback position. The marker may be initially included in the playbar when the device outputs the GUI to the user device, or may be added by the device to the playbar upon the initiation of the playback. An example of a marker is illustrated as marker 810 in the playbar 200 in the use case in below FIGS. 8A to 8H.

At operation S730, the device may be configured to update the graph in synchronization with the changes in the position of the marker along the playback timeline. Specifically, upon initiation of the playback, the marker may start moving along the playback timeline. In this regard, the device may track the changes in the position of the marker along the playback timeline, and continuously provide dynamic feedback by visually updating the graph and visual element(s) therein in real-time (or near-real-time).

Descriptions of an example use case associated with the outputting of the graph and dynamically updating the graph are provided below with reference to FIGS. 8A to 8H. Referring first to FIGS. 8A and 8B, which illustrate the playbar and the graph, respectively, outputted by the device when the playback of the log file is initiated.

As illustrated in FIG. 8A, upon initiation of the playback of the log file, the position of the marker 810 may continuously change (e.g., move from “00:00:000” to “Tx”). Concurrently with updating the position of the marker 810 on the playbar 200, the device may also output and continuously (or periodically) update the graph 800 in synchronization with the changes in the position of the marker 810 along the playback timeline. For instance, in the example of FIG. 8A, the marker 810 moves from a first position (00:00:000) to a second position (Tx). Accordingly, the device may update the second interactive element 230 (e.g., from a play button to a pause button) to allow the user to pause the playback when required, and may output the graph of FIG. 8B and continuously updating/plotting the graph along with the movement of the marker 810 during the playback. In some example embodiments, instead of or in addition to the pause button, the device may update the second interactive element 230 from a play button to a stop button to allow the user to stop the playback when required, from a play button to a record button to allow the user to record the playback when required, and the like.

Referring next to FIGS. 8C and 8D, which illustrate the playbar and the graph, respectively, outputted and updated by the device in continuation to the playbar and graph in FIGS. 8A and 8B, respectively. Specifically, in the example of FIGS. 8C and 8D, the playback enters the error zone. For instance, in the example of FIG. 8C, the marker 810 moves from the second position (Tx) to a third position (Ty) that is within the error zone (starting at T1 and ending at T2). Accordingly, the device may update/plot the graph 800 in FIG. 8D along with the movement of the marker 810 during the playback, while emphasizing the error zone on the graph 800 (e.g., filling the error zone with a specific pattern, etc.).

Referring next to FIGS. 8E and 8F, which illustrate the playbar and the graph, respectively, outputted and updated by the device in continuation to the playbar and graph in FIGS. 8C and 8D, respectively. Specifically, in the example of FIGS. 8E and 8F, the playback exits the error zone. For instance, in the example of FIG. 8E, the marker 810 moves from the third position (Ty) to a fourth position (Tz) that is outside of the error zone. Accordingly, the device may output the graph 800 of FIG. 8F that fully illustrates the error zone, while continuously updating/plotting the graph along with the movement of the marker 810 during the playback.

Referring next to FIGS. 8G and 8H, which illustrate the playbar and the graph, respectively, outputted and updated by the device in continuation to the playbar and graph in FIGS. 8E and 8F, respectively. In the example of FIGS. 8G and 8H the playback is completed. For instance, in the example of FIG. 8G, the marker 810 returns to the first position (00:00:000), indicating that the playback is completed. Accordingly, the device may update the second interactive element 230 (e.g., from a pause button to a play button) to allow the user to again initiate the playback when required, and may output the graph 800 of FIG. 8H that illustrates the complete graph 8H and stops updating the graph.

It is contemplated that the example use case in FIGS. 8A to 8H is merely an example, and the playback, graph plotting, etc., may be performed in any other suitable manner and/or may involve more/less operations, without departing from the scope of the present disclosure. For instance, additional information (e.g., information of the error zone, signal A, signal B, etc.) may be presented in the graph and may be continuously updated along with the playback and the graph plotting, the updating of the playbar and graph may be paused/stopped in response to another user interaction with the second interactive element, and the like.

It is contemplated that, the methods, operations, and use cases described above with reference to FIGS. 2A to 8H are merely examples and the scope of the present disclosure should not be limited thereto. Specifically, one or more operations in FIGS. 2A to 8H may be performed differently, fewer or additional operations may be involved, and the like, without departing from the scope of the present disclosure.

### Examples of Device

FIG. 9 illustrates a diagram of example components of a device 900, according to one or more example embodiments. The device 900 may refer to the playback device (e.g., device 111 in FIG. 1A) and/or the test device that implements a playback component (e.g., device 112 in FIG. 1B).

As illustrated in FIG. 9, the device 900 may include at least one bus 901, at least one processor 902, at least one memory 903, at least one storage component 904, at least one input component 905, at least one output component 906, and at least one communication interface 907.

It is contemplated that the device 900 may include more or fewer components than illustrated in FIG. 9, without departing from the scope of the present disclosure. For instance, in some example embodiments, the device 900 may include a plurality of storage components 904, the input component 905 and the output component 906 may be implemented as a transceiver component, the memory 903 and storage component 904 may be implemented as a memory storage, and the like.

The bus 901 may be configured to facilitate or enable communications among the components of the device 900. Specifically, the bus 901 may communicatively couple the components to each other and provide a means for data transfer and flow of control signals between the components. The bus 901 may include one or more of: an internal bus, an address bus, a data bus, a control bus, a controller area network (CAN) bus, an Ethernet bus, a peripheral component interconnect express (PCIe) bus, and any other suitable type of bus that can be implemented in the device 900 to enable communication and coordination between the components within the device 900 in real-time (or near-real-time/non-real-time).

The processor 902 may be implemented in hardware, firmware, or a combination of hardware and software, and may be configured to handle real-time (or near real-time/non-real-time) data processing and control of the device 900. The processor 902 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the device 900. In some example implementations, the processor 902 may be capable of being programmed to perform one or more operations described herein. Further, the processor 902 may include a plurality of processing units, each of which may be dedicated to performing a specific operation.

The memory 903 may include one or more storage mediums for storing temporary data, runtime variables, program instructions, and buffers required for the operations of the device 900. The memory 903 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the device 900 to store information and/or instructions for use by the processor 902.

The storage component 904 may be configured to store non-volatile data, such as firmware, configuration settings, calibration data, information, and/or software related to the operation and use of the device 900. For example, the storage component 904 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the memory 903 and/or the storage component 904 may be configured to store computer-readable or computer-executable instructions for implementing one or more operations of the device 900. The memory 903 and/or the storage component 904 may provide the stored information for the execution of the processor 902. Furthermore, the memory 903 and/or the storage component 904 may include data or information that may be utilized by the processor 902 to test the vehicle applications, such as the log files, analyzed data associated with the log files, previously identified test errors, test scenarios, logger settings, and the like. Further, the memory 903 and/or the storage component 904 may be configured to store one or more data involved in the operations of the device 900, such as the instructions generated by the device during the operations, the data or message provided by another devices, the results of the testing, and the like.

The input component 905 may include one or more input components that permit the device 900 to receive information, such as via user input (e.g., a touch screen display, a keyboard, a keypad, a mouse, a button, a switch, and/or a microphone). The output component 906 may include one or more output components that provide output information from the device 900 (e.g., a display, a speaker, a navigation device, one or more light-emitting diodes (LEDs), etc.) According to embodiments, the input component 905 and/or the output component 906 may be optional and may be excluded from the device 900.

The communication interface 907 may include a transceiver-like component (e.g., a transceiver and/or a separate receiver and transmitter) that enables the device 900 to communicate with other components (e.g., ECUs, user devices, etc.), such as via a wired connection, a wireless connection, or a combination of wired and wireless connections. For example, communication interface 907 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 907 may include at least one input/output (I/O) interface, at least one network interface, at least one storage interface, or the like, that enable the components 902-906 to communicate with other components. Further, the communication interface 907 may include one or more application programming interfaces (APIs) that allow the device 900 (or one or more components included therein) to communicate with one or more software applications (e.g., software application managed by the ECUs, etc.).

Computer-executable instructions (e.g., software instructions, etc.) may be read into memory 903 and/or storage component 904 from another computer-readable medium or from another device (e.g., a remote server, an external storage, etc.) via, for example, the communication interface 907. When executed, the computer-executable instructions stored in memory 903 and/or storage component 904 may cause the processor 902 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the "C" programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or diagram block or blocks.

The flowchart and diagrams in the Figures illustrate the architecture, functionality, and operation of possible implementations of systems, methods, and computer-readable media according to various embodiments. In this regard, each block in the flowchart or diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the diagrams and/or flowchart illustration, and combinations of blocks in the diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for presenting a test error of a performed test to a user, the method comprising:
receiving, by a device, a log file associated with the performed test; and
outputting, by the device and to a user device associated with the user, a graphical user interface (GUI) that presents information of the log file;
wherein the GUI comprises a playbar that includes:
a playback timeline visually representing a duration of the performed test,
a first interactive element visually representing an error zone corresponding to a portion of the log file associated with the test error, wherein the first interactive element is configured to enable the user to interact with the test error; and
a second interactive element configured to enable the user to control the playback of the information of the log file along the playback timeline.

2. The method according to claim 1, further comprising:
receiving, by the device and from the user device, a first user interaction with the first interactive element; and
outputting, by the device and to the user device, information associated with the error zone.

3. The method according to claim 2, wherein the information associated with the error zone comprises at least one of: an error identification, an error context, an error reason, an error impact, a log file excerpt associated with the test error, and a suggested action to address the test error.

4. The method according to claim 1,
wherein the portion of the log file associated with the test error comprises:
a first portion associated with a first condition that serves as a reference in determining the test error;
a second portion associated with a second condition that caused the test error when compared to the first condition; and
a third portion associated with a third condition that is associated with both the first condition and the second condition;
wherein the first interactive element comprises:
a first interactive portion associated with the first portion of the log file;
a second interactive portion associated with the second portion of the log file; and
a third interactive portion associated with the third portion of the log file.

5. The method according to claim 4, wherein the first interactive portion, the second interactive portion, and the third interactive portion are visually distinguished from each other.

6. The method according to claim 4, further comprising:
receiving, by the device and from the user device, a user interaction with one of: the first interactive portion, the second interactive portion, and the third interactive portion;
outputting, by the device and to the user device, information associated with the first condition if the user interaction is associated with the first interactive portion;
outputting, by the device and to the user device, information associated with the second condition if the user interaction is associated with the third interactive portion; and
outputting, by the device and to the user device, information associated with the third condition if the user interaction is associated with the third interactive portion.

7. The method according to claim 1, further comprising:
receiving, by the device and from the user device, a second user interaction with the second interactive element; and
outputting, by the device and to the user device, a graph that presents the information of the log file, wherein the error zone is visually emphasized in the graph.

8. The method according to claim 7,
wherein the playbar further comprises a marker that indicates a current playback position, and
wherein the outputting of the graph comprises:
upon receiving the second user interaction, initiating the playback of the information of the log file along the playback timeline;
outputting the graph that presents information of the log file corresponding to a starting position of the marker along the playback timeline; and
updating the graph in synchronization with changes in the position of the marker along the playback timeline.

9. The method according to claim 1, wherein the second interactive element comprises at least one of: a play button, a stop button, and a pause button.

10. A device for presenting a test error of a performed test to a user, the device comprising:
a memory storage storing computer-executable instructions; and
a processor communicatively coupled to the memory storage, wherein the processor is configured to execute the instructions to:
receive a log file associated with the performed test; and
output, to a user device associated with the user, a graphical user interface (GUI) that presents information of the log file,
wherein the GUI comprises a playbar that includes:
a playback timeline visually representing a duration of the performed test;
a first interactive element visually representing an error zone corresponding to a portion of the log file associated with the test error, wherein the first interactive element is configured to enable the user to interact with the test error; and
a second interactive element configured to enable the user to control the playback of the information of the log file along the playback timeline.

11. The device according to claim 10, wherein the processor is further configured to execute the instructions to:
receive, from the user device, a first user interaction with the first interactive element; and
output, to the user device, information associated with the error zone.

12. The device according to claim 11, wherein the information associated with the error zone comprises at least one of: an error identification, an error context, an error reason, an error impact, a log file excerpt associated with the test error, and a suggested action to address the test error.

13. The device according to claim 10,
wherein the portion of the log file associated with the test error comprises:
a first portion associated with a first condition that serves as a reference in determining the test error;
a second portion associated with a second condition that caused the test error when compared to the first condition; and
a third portion associated with a third condition that is associated with both the first condition and the second condition;
wherein the first interactive element comprises:
a first interactive portion associated with the first portion of the log file;
a second interactive portion associated with the second portion of the log file; and
a third interactive portion associated with the third portion of the log file.

14. The device according to claim 13, wherein the first interactive portion, the second interactive portion, and the third interactive portion are visually distinguished from each other.

15. The method according to claim 13, wherein the processor is further configured to execute the instructions to:
receive, from the user device, a user interaction with one of: the first interactive portion, the second interactive portion, and the third interactive portion;
output, to the user device, information associated with the first condition if the user interaction is associated with the first interactive portion;
output, to the user device, information associated with the second condition if the user interaction is associated with the third interactive portion; and
output, to the user device, information associated with the third condition if the user interaction is associated with the third interactive portion.

16. The device according to claim 10, wherein the processor is further configured to execute the instructions to:
receive, from the user device, a second user interaction with the second interactive element; and
output, to the user device, a graph that presents the information of the log file, wherein the error zone is visually emphasized in the graph.

17. The device according to claim 16,
wherein the playbar further comprises a marker that indicates a current playback position, and
wherein the processor is further configured to execute the instructions to output the graph by:
upon receiving the second user interaction, initiating the playback of the information of the log file along the playback timeline;
outputting the graph that presents information of the log file corresponding to a starting position of the marker along the playback timeline; and
updating the graph in synchronization with changes in the position of the marker along the playback timeline.

18. The method according to claim 10, wherein the second interactive element comprises at least one of: a play button, a stop button, and a pause button.

19. A non-transitory computer-readable recording medium having recorded thereon instructions executable by a device to cause the device to perform a method for presenting a test error of a performed test to a user, the method comprising:
receiving a log file associated with the performed test; and
outputting, to a user device associated with the user, a graphical user interface (GUI) that presents information of the log file,
wherein the GUI comprises a playbar that includes:
a playback timeline visually representing a duration of the performed test;
a first interactive element visually representing an error zone corresponding to a portion of the log file associated with the test error, wherein the first interactive element is configured to enable the user to interact with the test error; and
a second interactive element configured to enable the user to control the playback of the information of the log file along the playback timeline.

20. The non-transitory computer-readable recording medium according to claim 19, wherein the method further comprises:
receiving, from the user device, a first user interaction with the first interactive element; and
outputting, to the user device, information associated with the error zone.
